(19) United States
(12) Patent Application Publication
(10) Pub. No.: US 2010/0103767 A1
(43) Pub. Date: Apr. 29, 2010

(54) Inner-Circulation Emulsifying and Dispersing Arrangement

(76) Inventor: Sei Chugen, Tokyo (JP)

Correspondence Address: PAUL A. GUSS;PAUL A. GUSS ATTORNEY AT LAW, 1211 South Eads Street, No. 1502, ARLINGTON, VA, 22202, US

(21) Appl. No.: 12/604,341

(22) Filed: Oct. 22, 2009

(30) Foreign Application Priority Data
Oct. 23, 2008 (JP) 2008-273489

(51) Int. Cl. B01F 5/08; B01F 15/02; B01F 5/06

(52) U.S. Cl. 366/164.4

(57) ABSTRACT

An emulsifying and dispersing arrangement is provided, in which a handled material undergoes multi-time handling and a dispersion process, for achieving dispersion characteristics exhibiting uniformity of particle size. In addition, the temperature generated in the arrangement is controllable.

The present application claims priority based on Japanese Patent Application No. 2008-273489 filed on Oct. 23, 2008. The full disclosure of Japanese Patent Application No. 2008-273489 is hereby expressly incorporated by reference into the present specification. In the event of any errors in translation, or other conflicts, if any, between the present specification and Japanese Patent Application No. 2008-273489, the Japanese application shall be considered controlling.

### BACKGROUND OF THE INVENTION

1. Field of the Invention

The present invention relates to technologies concerned with arrangements for rotary emulsifying and dispersing.

2. Description of the Related Art

Rotary emulsifying and dispersing arrangements are widely used in industry. Previously used arrangements commonly contain a suction inlet like that of a centrifugal water pump, and in a casing contains impellers on the rotor thereof, similar to the impellers of a centrifugal water pump. The handled material is sucked into the casing upon turning of a rotor, and then the material is spiraled away from the rotor and hits upon a stator, which is set outside of the rotor, after achieving a given centrifugal power from the impellers of the rotor. The material finally is emulsified, dispersed and agitated, and is discharged from an outlet under pressure from the centrifugal power.

In order to achieve a dispersion property having a uniform granular size, the rotor and stator either are constructed as a multi-stage type, like that of a multi-stage pump, or are constructed so as to connect the suction inlet in the dispersing arrangement with a retrieval tank into which the material is dischargeable, so that the material can be redirected into the arrangement, and be treated a plurality of times and thus achieve a uniform granular size. However, when a multi-stage rotor is applied, high pressure will occur similar to multi-stage pumping functions. Therefore, reasonably, cooling water for a mechanical seal in such an arrangement should be highly pressurized, and an auxiliary supercharging pump, which is used for pressuring the arrangement, is a must. Also, redirection of material from the retrieval tank into the arrangement makes the system an open system. Thus, it is difficult to achieve a continuous process, as in a closed system.

### SUMMARY OF THE INVENTION

An object of the present invention is to provide a dispersing arrangement, in which a material can achieve and undergo random multi-time handling in a continuous process, in a closed loop system, without generating high pressure.

In order to achieve the above object, the rotary emulsifying and dispersing arrangement functions in a similar manner as a centrifugal water pump, because centrifugal power is generated by turning of a rotor. The principles of a previously used dispersion arrangement are shown in FIG. 3, whereas the principles of the present invention are shown in FIG. 1. A flow channel 6, which runs through a stator 2, is constructed in front of the first stator 2-2 in the casing 5 of the arrangement, so that the handled material, which is discharged from the last rotor 1-1, can be redirected into the suction inlet via the flow channel 6, whereupon depressurizing at the suction inlet is achieved.

### EFFECTS OF THE INVENTION

As mentioned above, the handled material, which is discharged from the last rotor 1-1, becomes depressurized at the suction inlet in the first rotor 1-2 via the flow channel 6, which is configured so as to run through the stator in front of the first stator 2-2 in the casing 5. By adjusting the clearance of the flow channel 6, the pressure that occurs in the casing 5 of the dispersing arrangement also can be adjusted. Furthermore, a uniform particle size can be achieved in the handled material, which is discharged from the last rotor 1-1, and the handled material undergoes reagitation and redispersion, thereby acquiring improved properties of dispersion.

### BRIEF DESCRIPTION OF THE DRAWINGS

FIG. 1 shows a concerned principle view of the present invention;

FIG. 2 is a principle view showing placement of a check valve in the present invention;

FIG. 3 is a principle view of a conventional and previously used emulsifying and dispersing arrangement;

FIG. 4 is a structural view of the present invention;

FIG. 5 is a structural view illustrating placement of a barrier shelf in the present invention; and

FIG. 6 is a structural view showing placement of a check valve 9 in the present invention.

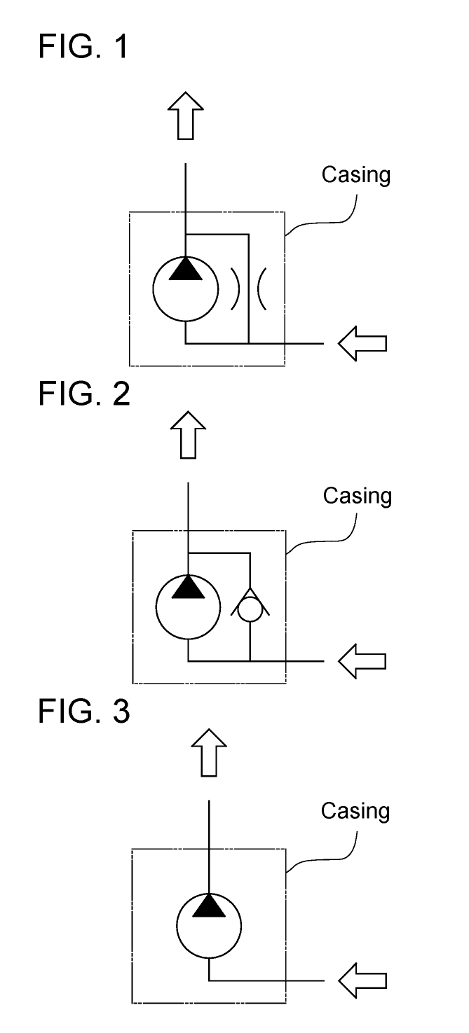

### DETAILED DESCRIPTION OF THE PREFERRED EMBODIMENT

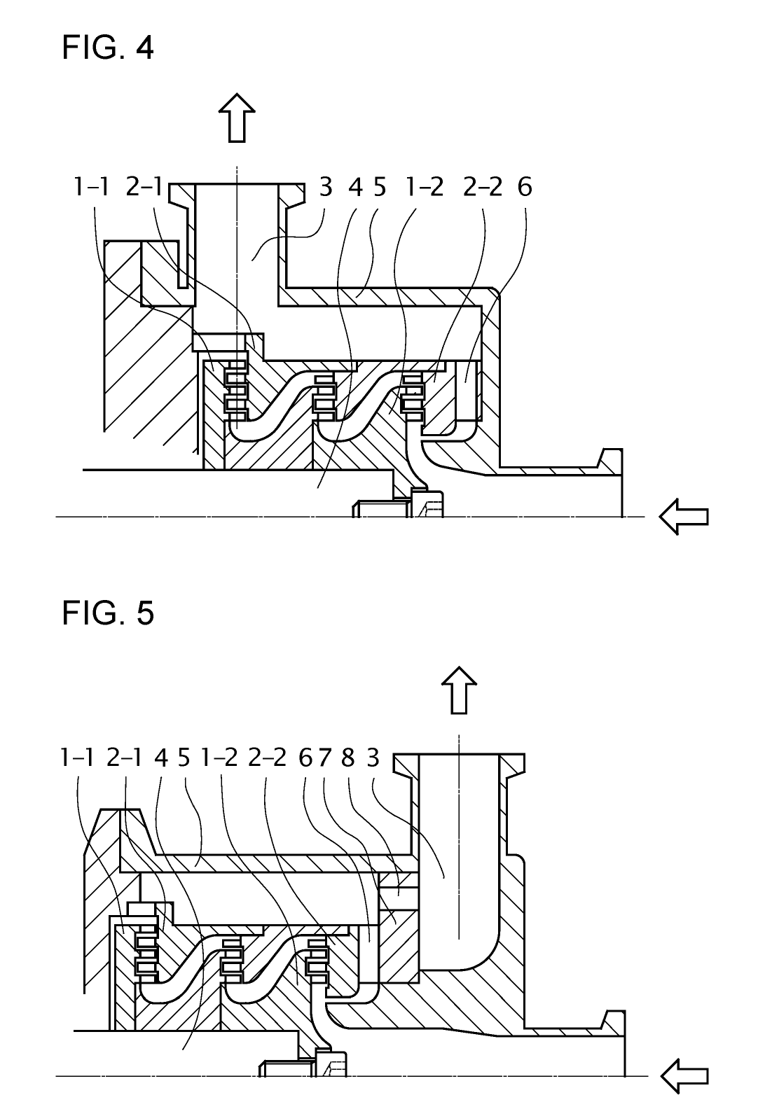

As shown in FIG. 4, the present invention is constituted by a casing 5, which is situated firmly on a base, a fixed stator 2, a freely-turnable shaft 4 and a rotor 1, which turns together with the shaft 4. Also, the handled material, which is discharged from the last rotor 1-1, is redirected into the suction inlet in the first rotor 1-2 via a flow channel 6, which is constructed so as to run through the stator prior to the first stator 2-2 in the casing 5. By adjusting the clearance of the flow channel 6, the pressure that occurs in the casing 5 of the arrangement can also be adjusted.

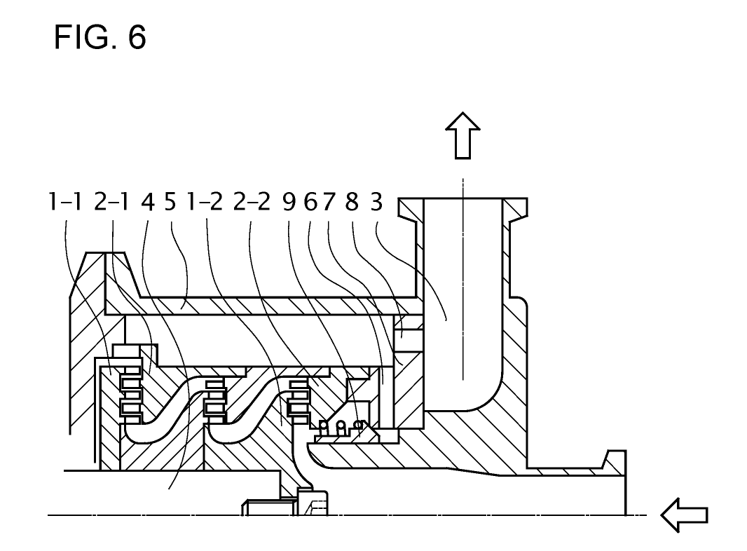

The flow channel 6 in the inner-circulation emulsifying and dispersing arrangement can also include a check valve 9, as shown in FIG. 6, in order to control the pressure inside the casing 5. FIG. 2 is a schematic structural illustration showing such an arrangement.

The handled material inside the casing 5 rotates toward the outlet 3 with different rotating diameters, according to different specific gravities of the particles. As shown in FIG. 5, the present invention is designed so as to move the outlet 3 prior to the flow channel 6, while setting a barrier shelf 7 between the flow channel 6 and the outlet 3. Most importantly, a gradual pore 8, which is set at a different place in the barrier shelf 7, will allow only a material having a set fineness to run therethrough, while the remaining material still undergoes agitation and dispersion after being redirected via the flow channel 6.

### INDUSTRIAL APPLICABILITY

According to the above-described inner-circulation structure, the pressure that occurs in the casing 5 can effectively be controlled without the need for supplying cooling water for the mechanical seal from a supercharging pump, irrespective of whether the stages of the rotor are increased or the rotation rate is increased. Also, the handled material undergoes reagitation and redispersion after running back via the flow channel 6, thereby achieving improved dispersion characteristics.

Furthermore, placement of the barrier shelf 7 and the gradual pore 8 permit only materials having a certain fineness to run therethrough, while the remaining material undergoes reagitation and redispersion. The arrangement thus enjoys a function of graduation, in order to improve the dispersion characteristics.

### DESCRIPTION OF REFERENCE CHARACTERS

1-1 last rotor
1-2 first rotor
2-1 last stator
2-2 first stator
3 outlet
4 shaft
5 casing
6 flow channel
7 barrier shelf
8 gradual pore
9 check valve

What is claimed is:

1. A rotary emulsifying and dispersing arrangement comprising:
a casing (5) situated firmly on a base, and having a fixed stator (2), a freely turnable shaft (4), and a rotor (1) that rotates together with said shaft (4) disposed in said casing (5),
wherein a handled material, which is discharged from a last rotor (1-1) is redirected into a suction inlet disposed in a first rotor (1-2) via a flow channel (6), said flow channel (6) being constructed so as to run through said stator (2) before said first stator (2-2), and
wherein adjustment of a clearance of said flow channel (6) is effective to adjust a pressure that occurs in said casing (5) of said rotary emulsifying and dispersing arrangement.

2. The rotary emulsifying and dispersing arrangement according to claim 1, wherein a check valve (9) is disposed in said flow channel (6) in order to control the pressure generated in said casing (5).

3. The rotary emulsifying and dispersing arrangement according to claim 1, wherein a barrier shelf (7) is disposed between said flow channel (6) and an outlet (3) by moving said outlet (3) before said flow channel (6), and wherein a gradual pore (8), which is disposed at a different position in said barrier shelf (7) allows only a material having a predetermined fineness to run therethrough, while the remaining material, which is not of said predetermined fineness, undergoes reagitation and redispersion via said flow channel (6).

4. The rotary emulsifying and dispersing arrangement according to claim 2, wherein a barrier shelf (7) is disposed between said flow channel (6) and an outlet (3) by moving said outlet (3) before said flow channel (6), and wherein a gradual pore (8), which is disposed at a different position in said barrier shelf (7) allows only a material having a predetermined fineness to run therethrough, while the remaining material, which is not of said predetermined fineness, undergoes reagitation and redispersion via said flow channel (6).
